(19) United States
(12) Patent Application Publication
(10) Pub. No.: US 2006/0172608 A1
(43) Pub. Date: Aug. 3, 2006

(54) Industrial ethernet connector pin orientation

(76) Inventor: Jack E. Caveney, Hinsdale, IL (US)

Correspondence Address: PANDUIT CORP., LEGAL DEPARTMENT - TP12, 17301 SOUTH RIDGELAND AVENUE, TINLEY PARK, IL, 60477, US

(21) Appl. No.: 11/344,394

(22) Filed: Jan. 31, 2006

Related U.S. Application Data
(60) Provisional application No. 60/648,660, filed on Jan. 31, 2005.

(51) Int. Cl. H01R 24/00

(52) U.S. Cl. 439/676

(57) ABSTRACT

An industrial ethernet connector has four pairs of conductors. The connector includes a first pair of conductors defining a first axis and a second pair of conductors defining a second axis. The second axis is orthogonal to the first axis.

### CROSS-REFERENCE TO RELATED APPLICATIONS

This application claims priority to U.S. Provisional Application Ser. No. 60/648,660, filed on Jan. 31, 2005, the entirety of which is hereby incorporated by reference.

### BACKGROUND OF THE INVENTION

The present invention is directed to an industrial ethernet connector and, more particularly, to an industrial ethernet connector pin orientation.

Communication cables comprised of multiple twisted pairs of conductors are common, with 4-pair cables being widely used. In high-speed data networks, crosstalk is caused by electromagnetic interference within a communications cable. Crosstalk occurring within a cable includes near-end crosstalk (NEXT) and far-end crosstalk (FEXT).

Suppression of crosstalk in communication systems is an increasingly important practice for improving systems' reliability and the quality of communication. Specifically, suppression of crosstalk in communication channels is important, because crosstalk can reduce the signal-to-noise ratio in a communication channel and increase the channel's bit error rate. As communication bandwidth increases, so does the importance of reducing or eliminating signal crosstalk.

### SUMMARY OF THE INVENTION

It would be desirable to provide an industrial ethernet connector pin orientation that reduces or eliminates signal crosstalk.

An industrial ethernet connector has four pairs of conductors. The connector includes a first pair of conductors defining a first axis and a second pair of conductors defining a second axis. The second axis is orthogonal to the first axis.

Preferably, the connector includes a third pair of conductors defining a third axis. The third axis is orthogonal to the first axis.

Preferably, the connector includes a fourth pair of conductors defining a fourth axis. The fourth axis is orthogonal to the first axis.

The connector includes a first pair of conductors having a first pin and a second pin, and a second pair of conductors having a third pin and a fourth pin. Each of the third pin and the fourth pin is equidistantly-spaced from each of the first pin and the second pin, respectively.

Preferably, the connector includes a third pair of conductors having a fifth pin and a sixth pin. Each of the fifth pin and the sixth pin is equidistantly-spaced from each of the first pin and the second pin, respectively.

Preferably, the connector includes a fourth pair of conductors having a seventh pin and an eighth pin. Each of the seventh pin and the eighth pin is equidistantly-spaced from each of the first pin and the second pin, respectively.

### BRIEF DESCRIPTION OF THE FIGURES

FIG. 1 is a schematic view of an industrial ethernet connector pin orientation according to the present invention;

FIG. 2 is a schematic view of an industrial ethernet connector pin orientation according to a second embodiment of the present invention;

FIG. 3 is a schematic view of an industrial ethernet connector pin orientation according to a third embodiment of the present invention; and

FIG. 4 is a schematic view of an industrial ethernet connector pin orientation according to a fourth embodiment of the present invention.

### DETAILED DESCRIPTION OF PREFERRED EMBODIMENTS

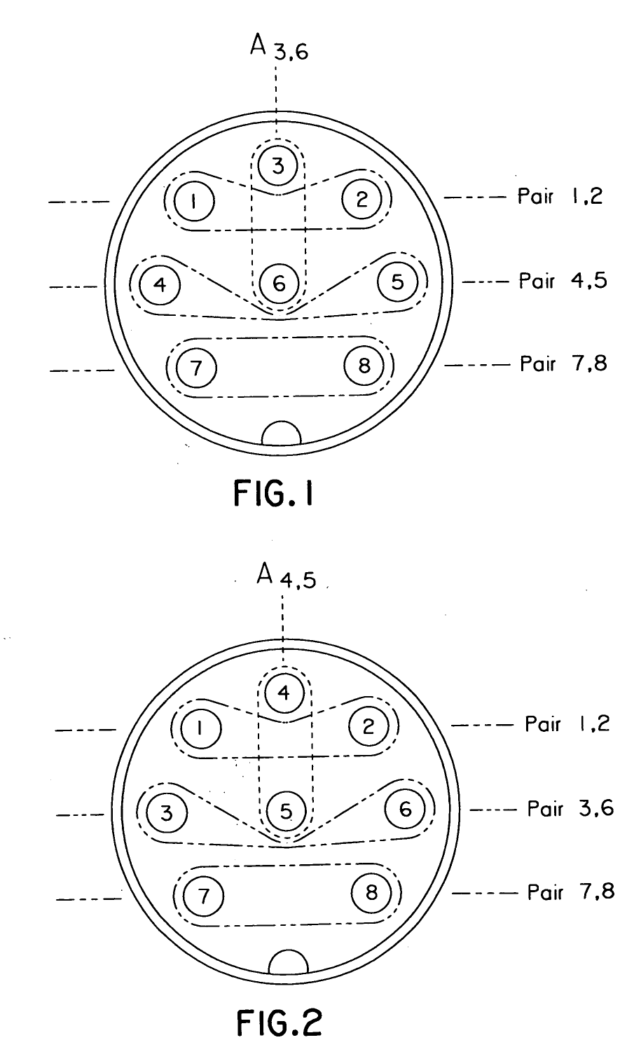

As known in the art, 4-pair cables include pair 1,2; pair 3,6; pair 4,5; and pair 7,8. As shown in FIG. 1, the axis of pair 3,6 is orthogonal to the axes of all other pairs. Specifically, the axis of pair 3,6 is orthogonal to the axis of pair 1,2. Likewise, the axis of pair 3,6 is orthogonal to the axis of pair 4,5. Similarly, the axis of pair 3,6 is orthogonal to the axis of pair 7,8. It is likewise contemplated that pair 1,2; pair 4,5; and pair 7,8 may appear in any order.

As best seen in FIG. 1, each pin of pair 3,6 is equidistantly-spaced from each pin of pair 1,2. Similarly, each pin of pair 3,6 is equidistantly-spaced from each pin of pair 4,5. Likewise, each pin of pair 3,6 is equidistantly-spaced from each pin of pair 7,8. It is likewise contemplated that the actual pin order for pair 3,6 may be reversed from that shown in FIG. 1. Accordingly, as a result of this particular pin orientation, there is zero net crosstalk between pair 3,6 and any of the other three pairs.

FIG. 2 is similar to FIG. 1, except that pair 4,5 and pair 3,6 have been interchanged. As shown in FIG. 2, the axis of pair 4,5 is orthogonal to the axes of all other pairs. It is likewise contemplated that the actual pin order for pair 4,5 may be reversed from that shown in FIG. 2. Accordingly, as a result of this particular pin orientation, there is zero net crosstalk between pair 4,5 and any of the other three pairs.

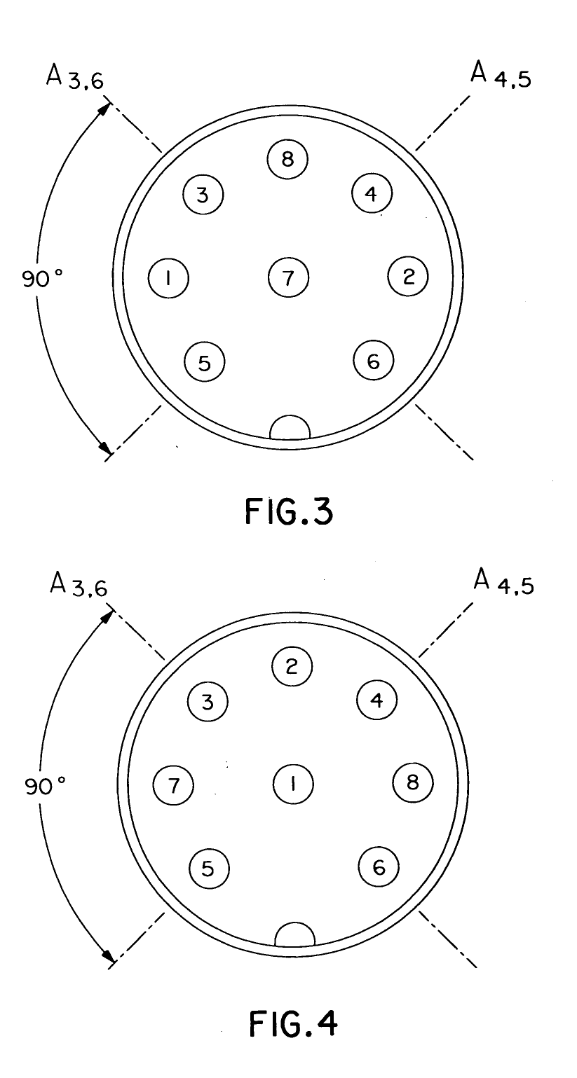

FIGS. 3 and 4 illustrate different 4-pair cable pin orientations. FIG. 4 is similar to FIG. 3, except that pair 1,2 and pair 7,8 have been interchanged. As shown in FIGS. 3 and 4, the axis of pair 3,6 is orthogonal to the axis of pair 4,5. It is likewise contemplated that the actual pin order for pair 3,6 and pair 4,5 may be reversed from that shown in FIGS. 3 and 4. Similarly, it is contemplated that the actual pin order for pair 1,2 and pair 7,8 may be reversed from that shown in FIGS. 3 and 4. Accordingly, as a result of this particular pin orientation, there is zero net crosstalk between pair 3,6 and pair 4,5.

The disclosed invention provides multiple industrial ethernet connector pin orientations for 4-pair cable. It should be noted that the above-described illustrated embodiments and preferred embodiments of the invention are not an exhaustive listing of the form such an industrial ethernet connector pin orientation in accordance with the invention might take; rather, they serve as exemplary and illustrative of embodiments of the invention as presently understood. Many other forms of the invention are believed to exist.

1. An industrial ethernet connector having four pairs of conductors, the connector comprising:
a first pair of conductors defining a first axis; and
a second pair of conductors defining a second axis, wherein the second axis is orthogonal to the first axis.

2. The connector of claim 1, further comprising a third pair of conductors defining a third axis, wherein the third axis is orthogonal to the first axis.

3. The connector of claim 2, further comprising a fourth pair of conductors defining a fourth axis, wherein the fourth axis is orthogonal to the first axis.

4. An industrial ethernet connector having four pairs of conductors, the connector comprising:
a first pair of conductors having a first pin and a second pin; and
a second pair of conductors having a third pin and a fourth pin, wherein each of the third pin and the fourth pin is equidistantly-spaced from each of the first pin and the second pin, respectively.

5. The conductor of claim 4, further comprising a third pair of conductors having a fifth pin and a sixth pin, wherein each of the fifth pin and the sixth pin is equidistantly-spaced from each of the first pin and the second pin, respectively.

6. The connector of claim 5, further comprising a fourth pair of conductors having a seventh pin and an eighth pin, wherein each of the seventh pin and the eighth pin is equidistantly-spaced from each of the first pin and the second pin, respectively.
